(19) United States
(12) Patent Application Publication
(10) Pub. No.: US 2004/0010502 A1
(43) Pub. Date: Jan. 15, 2004

(54) In-memory database for high performance, parallel transaction processing

(76) Inventors: Joanes DePaula Bomfim, McLean, VA (US); Richard Stephen Rothstein, McLean, VA (US)

Correspondence Address: STAAS & HALSEY LLP, SUITE 700, 1201 NEW YORK AVENUE, N.W., WASHINGTON, DC, 20005, US

(21) Appl. No.: 10/193,672

(22) Filed: Jul. 12, 2002

(51) Int. Cl. G06F 7/00

(52) U.S. Cl. 707/100

(57) ABSTRACT

An in-memory file system supports concurrent clients allowing multiple updates on the same record by more than 1 of the clients, between commits, while maintaining commit integrity over a defined interval of processing. Moreover, a computer system processing transactions includes client computers concurrently transmitting messages. The computer system also includes servers, in communication with the client computers, receiving the messages, and in-memory databases, each in-memory database corresponding, respectively, to at least one of the servers, in which the servers store the messages in records of the respective in-memory databases, and the in-memory databases allow multiple updates on the same record by more than 1 of the client computers, between commits, while maintaining commit integrity over a defined interval of processing.

### CROSS REFERENCE TO RELATED APPLICATIONS

This application is related to GAP DETECTOR DETECTING GAPS BETWEEN TRANSACTIONS TRANSMITTED BY CLIENTS AND TRANSACTIONS PROCESSED BY SERVERS, U.S. Ser. No. 09/922,698, filed Aug. 7, 2001, the contents of which are incorporated herein by reference.

This application is related to HIGH PERFORMANCE TRANSACTION STORAGE AND RETRIEVAL SYSTEM FOR COMMODITY COMPUTING ENVIRONMENTS, attorney docket no. 1330.1111/GMG, U.S. Ser. No. ______, by Joanes Bomfim and Richard Rothstein, filed concurrently herewith, the contents of which are incorporated herein by reference.

This application is related to HIGH PERFORMANCE DATA EXTRACTING, STREAMING AND SORTING, attorney docket no. 1330.1113P, U.S. Ser.No. ______, by Joanes Bomfim, Richard Rothstein, Fred Vinson, and Nick Bowler, filed Jul. 2, 2002, the contents of which are incorporated herein by reference.

### BACKGROUND OF THE INVENTION

1. Field of the Invention

The present invention relates to in-memory databases, more particularly, to an in-memory database used in paralleled computing environments supporting high transaction rates, such as the commodity computing area.

2. Description of the Related Art

Databases stored on disks and databases used as memory caches are known in the art. Moreover, in-memory databases, or software databases, generally, are known in the art, and may support high transaction volumes. Data stored in databases is generally organized into records. The records, and therefore the database storing the records, are accessed when a processor either reads (queries) a record or updates (writes) a record.

To maintain data integrity, a record is locked during access of the record by a process, and this locking of the record continues throughout the duration of 1 unit of work and until a commit point is reached. Locking of a record means that processes other than the process modifying the record, are prevented from accessing the record. Upon reaching a commit point, the update on the record is finalized on the disk. If a problem with the record is encountered before the commit point is reached, the recovery process occurs, and the updates to that record and to all other records which occurred after the most recent commit point are backed out. That is, it is important for a database to enable commit integrity, meaning that if any process abnormally terminates, updates to records made after the most recent commit point are backed out and the recovery process is initiated.

After the unit of work is completed, the commit point is reached, and the record is successfully written to the disk, then the record lock is released (that is, the record is unlocked), and another process can modify the record.

FIG. 1 shows a computer system 10 of the related art which executes a business application such as a telecommunication billing system. In the computer system 10 of the related art, a telephone switch 12 transmits telephone messages to a collector 14, which periodically (such as every ½ hour) transmits entire files 16 to an editor 18. Editor 18 then transmits edited files 20 to formatter 22, which transmits formatted files 24 to pricer 26, which produces priced records 28. The lag time between the telephone switch 12 transmitting the phone usage messages and the pricer producing the priced records 28 depends on the time intervals of all data/file transfer points in this business process. In the example shown in FIG. 1, when the collector 14 transmits a file 16 every ½, the lag time is approximately ½ hour. Moreover, if there is a problem which requires recovery of the edited files 20 (for example), then further lag time is introduced into the system 10. In the computer system 10 shown in FIG. 1, the synchronization point (or synch point) is when the files are transmitted, such as when collector 14 transmits files 16 to an editor 18. A synchronization point or synchpoint refers to a database commit point or a data/file aggregate point in this document.

In a computer system which supports a high volume of transactions (such as the computer system 10 shown in FIG. 1), each transaction may initiate a process to access a record. Several records are typically accessed, and thus remain locked, over the duration of the time interval between commit points. For example, in current high volume transaction computer systems, commit points can be placed every 10,000 transactions, and can be reached every 30 seconds.

Although it would be possible to place a commit point after each access to each record, doing so would add overhead to processing of the transactions, and thus decrease the throughput of the computer system.

A problem with databases of the related art is that a record can be locked for the duration of the unit of work until the commit point is reached, thus preventing other processes from modifying the record.

Another problem with databases of the related art is that locking the record for the duration of the unit of work until the commit point is reached renders the record unavailable for access by other processes for a long period of time.

A further problem with the related art is that with records locked and unavailable, processing throughput is limited.

### SUMMARY OF THE INVENTION

An aspect of the present invention is to provide an in-memory database for paralleled computer systems supporting high transaction rates which enables multiple processes to update a record between commit points while maintaining commit integrity.

Another aspect of the present invention is to increase throughput of transactions in a computer system.

Still a further aspect of the present invention is to provide an in-memory database which locks a record only during the period of time that the record is being updated by a process, and which does not require a process to lock a records for the whole duration between two synchpoints or commits.

The above aspects can be attained by a system of the present invention that includes an in-memory file system supporting concurrent clients allowing multiple updates on the same record by more than 1 of the clients, between commits (or commitment points), while maintaining commit integrity over a defined interval of processing.

In addition, the present invention comprises a computer system processing transactions, client computers concurrently transmitting messages, servers in communication with the client computers and receiving the messages, and in-memory databases. Each in-memory database corresponding, respectively, to one or multiple of the servers with the servers storing the messages in records of the respective in-memory databases. The in-memory databases allow multiple updates on the same record by more than 1 of the client computers, between commits, while maintaining commit integrity over a defined interval of processing.

Moreover, the present invention includes a method of a computer system processing transactions and a computer-readable medium storing a program which when executed by the computer system executes the functions including supporting, through an in-memory database system, concurrent clients, and allowing multiple updates on the same record of the in-memory database system by more than 1 of the clients, between commits, while maintaining commit integrity over a defined interval of processing.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a computer system of the related art which executes a business application such as a telecommunication billing system.

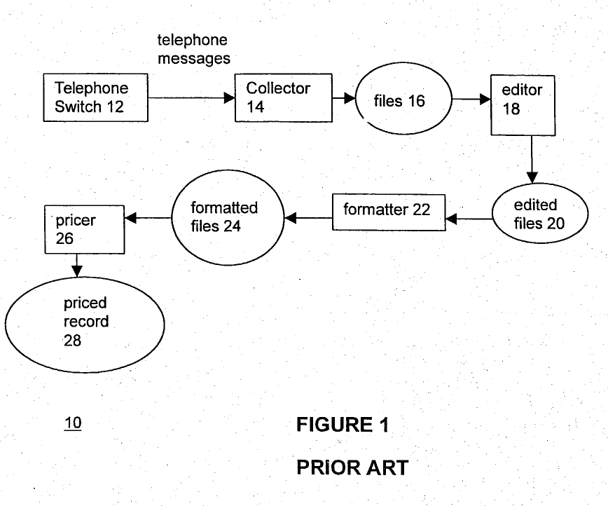

FIG. 2 shows major components of the present invention in context of a high performance transaction support system.

FIG. 3 shows a sample configuration of clients, servers, the in-memory database of the present invention, the gap analyzer, and the transaction storage and retrieval system.

FIG. 4 shows the configuration of the in-memory database of the present invention and its associates.

FIG. 5 shows a pairing of machines including the in-memory database of the present invention, to configure a failover cluster.

FIG. 6 shows a monitor screen for the in-memory database of the present invention.

FIG. 7 shows an example of an in-memory database API of the present invention.

FIG. 8 shows the organization of the index and data areas in the memory of the in-memory database of the present invention.

FIG. 9 shows the synchpoint signals in the in-memory database of the present invention's high performance system.

FIG. 10 shows incremental and full backups performed by the in-memory database of the present invention.

FIG. 11 shows a sequence of events for one processing cycle in a streamlined, 2-phase commit processing of the in-memory database of the present invention.

### DETAILED DESCRIPTION OF THE PREFERRED EMBODIMENTS

Before a detailed description of the present invention is presented, a brief overview is presented of a high performance transaction support system in which the present invention is included.

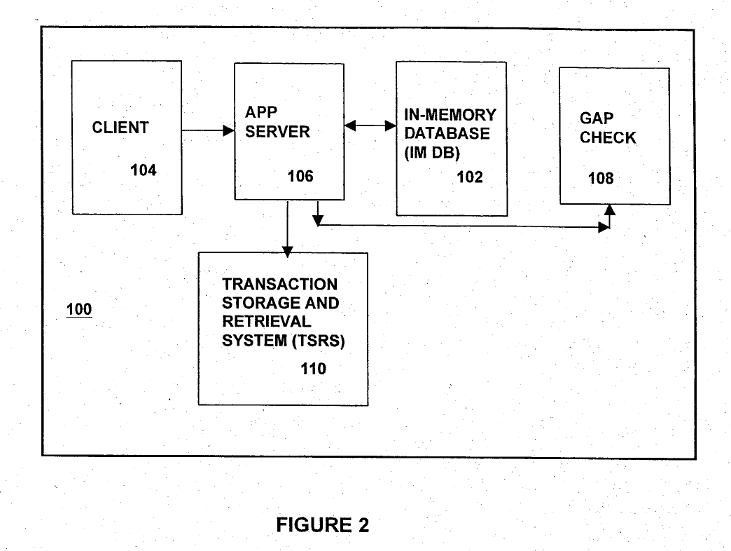

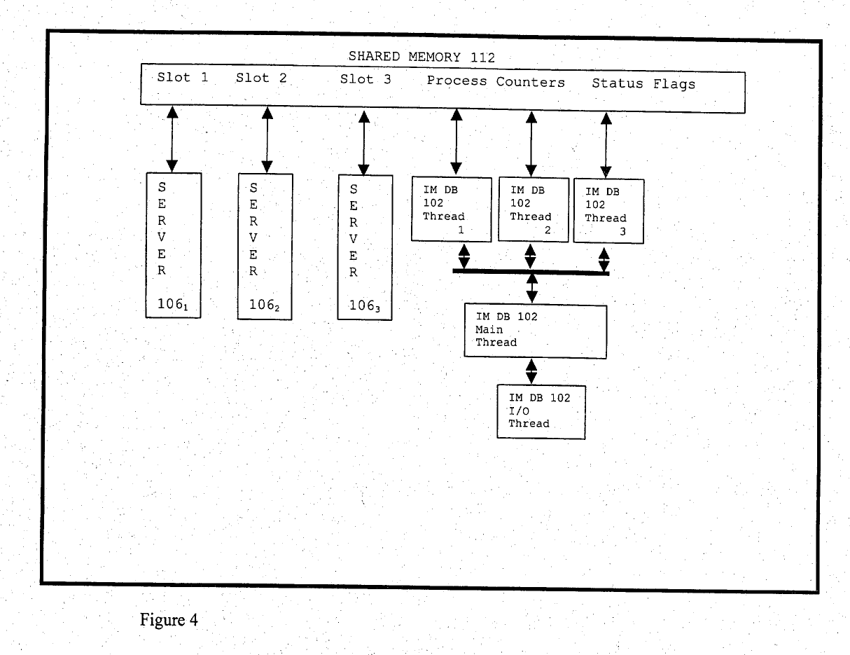

FIG. 2 shows major components of a computer system of a high performance transaction support system 100. The high performance transaction support system 100 shown in FIG. 2 includes an in-memory database (IM DB) 102 of the present invention. The in-memory database 102 of the present invention is disclosed in further detail herein below, beginning with reference to FIG. 4.

Returning now to FIG. 2, the high performance transaction support system 100 also includes a client computer 104 transmitting transaction data to an application server computer 106. Queries and updates flow between the application server computer 106 and the in-memory database 102 of the present invention. Lists of processed transactions flow from the application server computer to the gap check (or gap analyzer) computer 108. The application server computer 106 also transmits the transaction data to the transaction storage and retrieval system 110. Although each of the above-mentioned in-memory database 102, client computer 104, application server 106, gap check computer 108, and transaction storage and retrieval system 110 is disclosed as being separate computers, one or more of the mentioned in-memory database 102, client computer 104, application server 106, gap check computer 108, and transaction storage and retrieval system 110 could reside on the same, or a combination of different, computers. That is, the particular hardware configuration of the high performance transaction support system 100 may vary.

The client computer 104, the application server computer 106, and the gap check computer 108 are disclosed in GAP DETECTOR DETECTING GAPS BETWEEN TRANSACTIONS TRANSMITTED BY CLIENTS AND TRANSACTIONS PROCESSED BY SERVERS, U.S. Ser. No. 09/922,698, filed Aug. 7, 2001, the contents of which are incorporated herein by reference.

The transaction storage and retrieval system 110 is disclosed in HIGH PERFORMANCE TRANSACTION STORAGE AND RETRIEVAL SYSTEM FOR COMMODITY COMPUTING ENVIRONMENTS, attorney docket no. 1330.1111, U.S. Ser. No. ______, filed concurrently herewith, the contents of which are incorporated herein by reference.

The high performance transaction support system 100 shown in FIG. 2 includes the major components in a suite of end-to-end support for a high performance transaction processing environment. That is, more than one client computer 104 and/or server 106 may be included in the high performance transaction support system 100 shown in FIG. 2. If that is the case, then the system 100 could also include 1 in-memory database 102 of the present invention for each server 106.

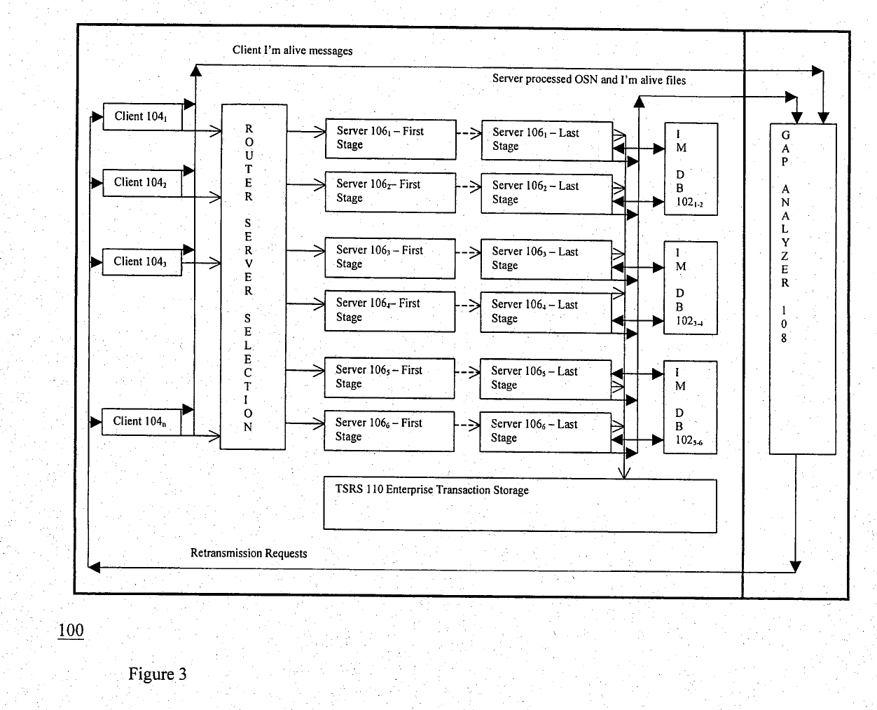

FIG. 3 shows a more detailed example of the computer system 100 shown in FIG. 2. The computer system 100 shown in FIG. 3 includes clients 104, servers 106, the in-memory database 102 of the present invention, the gap analyzer (or gap check) 108, and the transaction storage and retrieval system 110.

An example of data and control flow through the computer system 100 shown in FIG. 3 includes:

Client computers 104, also referred to as clients and as collectors, receive the initial transaction data from outside sources, such as point of sale devices and telephone switches (not shown in FIG. 3).

Clients 104 assign a sequence number to the transactions and log the transactions to their local storage so the clients 104 can be in a position to retransmit the transactions, on request, in case of communication or other system failure.

Clients 104 select a server 106 by using a routing process suitable to the application, such as selecting a particular server 106 based on information such as the account number for the current transaction.

Servers 106 receive the transactions and process the received transactions, possibly in multiple processing stages, where each stage performs a portion of the processing. For example, server 106 can host applications for rating telephone usage records, calculating the tax on telephone usage records, and further discounting telephone usage records.

A local in-memory database 102 of the present invention may be accessed during this processing. The local in-memory database 102 supports a subset of the data maintained by the enterprise computer or database system. As shown in FIG. 3, a local in-memory database 102 may be shared between servers 106 (such as being shared between 2 servers 106 in the example computer system 100 shown in FIG. 3).

Before a transaction is completed, the transaction is forwarded to Transaction Storage and Retrieval System (TSRS) 110 for long term storage.

Periodically, during independent synchpoint processing phases, clients 104 generate short files including the highest sequence numbers assigned to the transactions that the clients 104 transmitted to the servers 106.

Also periodically, during the synchpoints, servers 106 make available to the gap analyzer 108 a file including a list of all the sequence numbers of all transactions that the servers 106 have processed during the current cycle. At this point, the servers 106 also prepare a short file including the current time to indicate the active status to the gap analyzer 108.

An explanation of the in-memory database 102 of the present invention is presented in detail, after a brief overview of the gap analyzer 108 and a brief overview of the TSRS 110.

Brief Overview of the gap analyzer 108

The gap analyzer 108 wakes up periodically and updates its list of missing transactions by examining the sequence numbers of the newly arrived transactions. If a gap in the sequence numbers of the transactions has exceeded a time tolerance, the gap analyzer 108 issues a retransmission request to be processed by the affected client 104, requesting retransmission of the transactions corresponding to the gap in the sequence numbers. That is, the gap analyzer 108 receives server 106 information indicating which transactions transmitted by a client 104 through a computer communication network were processed by the server 106, and detects gaps between the transmitted transactions and the processed transactions from the received server information, the gaps thereby indicating which of the transmitted transactions were not processed by the server 106. Moreover, the gap analyzer creates a re-transmit request file for each client 104 indicating the transactions need to be re-processed. The clients 104 periodically pick up the corresponding re-transmit request files from the gap analyzer to re-transmit the transactions identified by the gap anlyzer.

Brief Overview of the TSRS 110

The TSRS 110 is a high performance transaction storage and retrieval system for commodity computing environments. Transaction data is stored in partitions, each partition corresponding to a subset of an enterprise's entities, for example, all the accounts that belong to a particular bill cycle can be stored in one partition. More specifically, a partition is implemented as files on a number of TSRS 110 machines, each one having its complement of disk storage devices.

Each one of the machines that make up a partition holds a subset of the partition data and this subset is referred to as a subpartition. When an application server 106 (or requestor) finishes processing a transaction and contacts the TSRS 110 to store the transaction data, a routing process directs the data to the machine that is assigned to that particular subpartition. The routing process uses the transaction's key fields, such as a customer account number, and thus ensures that transactions for the same key, such as an account, are stored in the same subpartition. The process is flexible and allows for transactions for very large accounts to span more than one machine.

The routing process as well as all the software to issue requests to the TSRS is provided as an add-on to the application server process. This add-on is called a requester and for this reason the TSRS 110 processes deal only with requesters and not directly with other components of the application servers 106. In the context of this application the terms requestors and application servers may be used interchangeably.

Within each TSRS 110 machine, multiple independent processes, called Input/Output Processors (IOPs) service the requests transmitted to them by their partner requesters. On each TSRS 110 machine, there is a dedicated IOP for each subpartition of data in the transaction processing system 100. An IOP is started for each data subpartition when the application servers 106 first register themselves with the TSRS 110.

When application servers 106 perform their periodic synchpoints, they direct the TSRS 110 to participate in the synchpoint operation; this ensures that the application servers 106's view of the transactions that they have processed and committed is consistent with the TSRS 110's view of the transaction data that it has stored.

The transaction data addressed by the TSRS 110 is sequential in nature, has already been logged in a prior phase of the processing, and typically does not require the level of concurrency protection provided by general purpose database software. The TSRS 110's use of its disk storage is based on dedicated devices and channels on the part of owning processes and threads, such that contention for the use of a device takes place only infrequently.

Overview of the In-memory database of the present invention

An overview of the in-memory database 102 of the present invention is now presented, with reference to the above-mentioned major components of the high performance transaction support system 100.

To achieve extremely high transaction rates in paralleled processing environments, the present invention comprises an in-memory database system supporting multiple concurrent clients (typically application servers, such as application server 106 shown in FIG. 2).

The in-memory database of the present invention functions on the premise that most operations of the computer system in which the in-memory database resides complete successfully. That is, the in-memory database of the present invention assumes that a record will be successfully updated, and thus, commits are placed between multiple data record updates. A data record is locked for the relatively small period of time (approximately 10-20 milliseconds per transaction) that the record is being updated in the in-memory database to enable multiple updates between commit points and therefore increase the throughput of the system. The process of backing up the in-memory database updates into the enterprise database is transparent to application servers 106. The in-memory database of the present invention maintains commit integrity. If updating the record, for example, meets an abnormal end, then the in-memory database of the present invention backs out the update to the record, and backs out the updates to other records, since the most recent commit point. The commits of the in-memory database of the present invention are physical commits set at arbitrary time intervals of, for example, every 5 minutes. If there is a failure (an abnormal end), then transactions processed over the past 5 minutes, at most, would be re-processed.

The present invention includes a simple application programming interface (API) for query and updates, dedicated service threads to handle requests, data transfer through shared memory, high speed signaling between processes to show completion of events, an efficient storage format, externally coordinated 2-phase commits, incremental and full backup, pairing of machines for failover, mirroring of data, automated monitoring and automatic failover in many cases. In the present invention, all backups are performed through dedicated channels and dedicated storage devices, to unfragmented pre-allocated disk space, using exclusive I/O threads. Full backups are performed in parallel with transaction processing.

That is, the present invention comprises a high performance in-memory database system supporting a high volume paralleled transaction system in the commodity computing arena, in which synchronous I/O to or from disk storage would threaten to exceed a time budget allocated to process each transaction. For example, assuming a PC with 2 GHz processing speed, a disk look-up takes about 5 ms, and a memory look-up takes about 0.2 ms. Assume that 1 transaction includes 10 different look-ups, for 100 transactions every second, total disk look-up time is 5×10×100 ms, which is 5 seconds; while total in-memory database look-up time is 0.2×10×100 ms, which is 0.2 seconds. Specifically, in this scenario, the transaction rate of 100 transactions per second is not achievable with disk I/O.

The general configuration of the in-memory database 102 of the present invention, and the relationship of the in-memory database 102 with servers 106, is illustrated in FIG. 4.

Typical requests made by transactions to the in-memory database 102 of the present invention originate from regular application servers 106 that send queries or updates to a particular key field such as account. Requests can also be sent from an entity similar to an application server within the range of entities controlled by a process of the present invention.

On startup, the in-memory database of the present invention process preloads its assigned database subset into memory before starting servicing requests from its clients 106 . All of the clients 106 of the in-memory database 102 of the present invention reside within the same computer under the same operating system image, and requests are efficiently serviced through the use of shared memory 112, dedicated service threads, and signals (such as process counters and status flags) that indicate the occurrence of events.

Each instance of the in-memory database 102 of the present invention is shared by several servers 106. Each server 106 is assigned to a communication slot in the shared memory 112 where the server 106 places the server's request to the in-memory database 102 of the present invention and from which the server retrieves a response from the in-memory database 102 of the present invention. The request may be a retrieval or update request.

That is, application servers 106 use their assigned shared memory slots to send their requests to the in-memory database 102 of the present invention and to receive responses from the in-memory database 102 of the present invention. Each server 106 has a dedicated thread within the in-memory database 102 of the present invention to attend to the server's requests.

The in-memory database 102 of the present invention includes separate I/O threads to perform incremental and full backups. The shared memory 112 is also used to store global counters, status flags and variables used for interprocess communication and system monitoring.

Mirroring, Monitoring and Failover

In a high performance computer system which includes an in-memory database of the present invention, machines (in which application servers 106 and in-memory databases 102 reside) are paired up to serve as mutual backups. Each machine includes local disk storage sufficient to store its own in-memory database of the present invention as well as to hold a mirror copy of its partner's database of the in-memory database of the present invention.

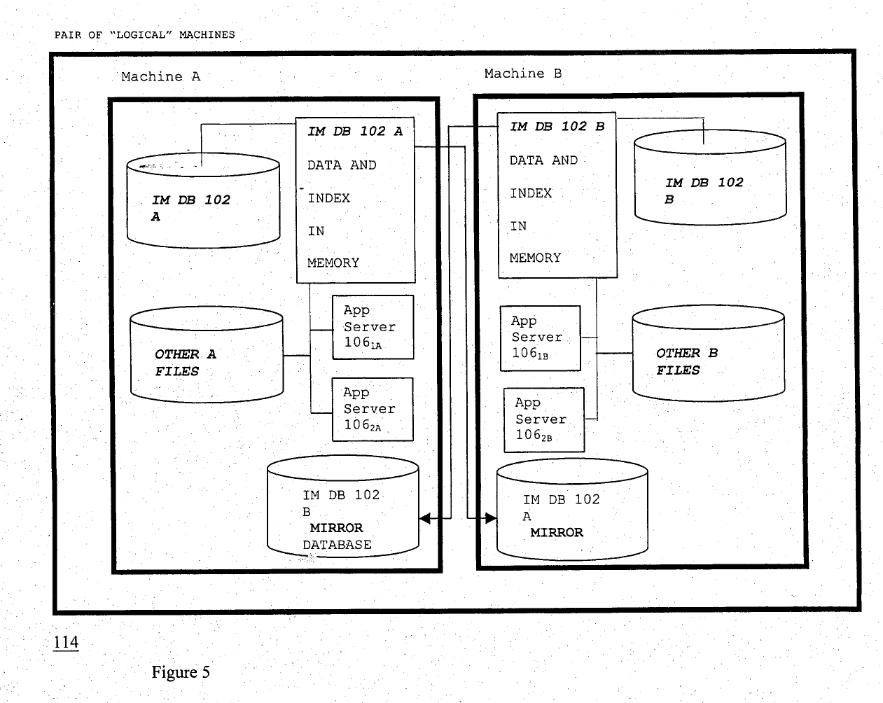

FIG. 5 shows a pair 114 of logical machines including application servers 106 and the in-memory database 102 of the present invention. That is, FIG. 5 shows a pairing of machines including the in-memory database 102 of the present invention, to configure a failover cluster. The present invention, though, is not limited to the failover cluster shown in FIG. 5, and supports failover clusters in which 3, 4, or n machines are grouped together to form a failover configuration.

FIG. 5 also shows the hot-stand-by in-memory log used in the in-memory database 102 of the present invention. The hot-stand-by in memory log refers to the mirroring databases' in-memory logs which track the IM DB changes in the corresponding primary MARIO IM DBs. The process of the in-memory logs of the mirroring databases shown in, and explained with reference to, FIG. 5.

As shown in FIG. 5, machine A hosts several application servers 106_{1A} and 106_{1B} sharing an instance of the in-memory database 102 of the present invention responsible for a collection of data records. Machine B is configured similarly, for a different collection of data records. Each machine A and B, in addition to having its own database of the in-memory database 102 of the present invention, hosts a mirror copy of the other machine's in-memory database of the present invention, in a paired failover configuration.

A machine of sufficient size and correct configuration may host more than 1 pair of “logical machines” A and B.

For example, a DELL 1650 can be used for the failover configuration shown in FIG. 5. In the example of FIG. 5, with the two connections between Machine A and the IM DB 102 A mirror, and Machine B and the IM DB 102 B mirror databases being high-speed ETHERNET connections through the PCI slots of Machine A and Machine B.

The in-memory database of the present invention also includes an in-memory log which is part of the in-memory database and which tracks the transactions applied (that is, data updates and inserts) to the in-memory database of the present invention. That is, the IM DB 102 A, IM DB 102 A mirror, IM DB 102 B, and IM DB 102 B mirror each include their own, respective in-memory logs.

Utilizing the high speed ETHERNET connections, when the in-memory log of the IM DB 102 A database is updated, the in-memory log of the IM DB 102 A mirror database is also updated through the dedicated ETHERNET connection between the two databases. The same update operations apply to the in-memory logs of the IM DB 102 B database and the IM DB 102 B mirror database. All updates to the IM DB since the last synchronization points are kept in the in-memory logs. The starting point of the current transaction is marked in the in memory log.

When Machine A fails, the IM DB 102 A mirror database residing on Machine B is used as the back-up database. Because the IM DB 102 A mirror database on Machine B has a hot-stand-by in-memory log, the IM DB 102 A mirror database on Machine B can first apply all updates since the last synch-point to the IM DB 102 A mirror database up to the end of the last successful transaction, then roll back the operations for the current transaction. From the perspective of the application, only the current transaction is rolled back. Using the in-memory log and the IM DB 102 A mirror database on Machine B, the process can continue from the end of the last completed transaction.

The “hot-stand-by” process described above reduces the number of transactions rolled back at database failures. Instead of rolling back to the last synchpoint (which is usually many transactions back), the “hot-stand-by” enables the back-up database to start from the beginning of the current transaction when the primary IM DB fails.

The machine configuration shown in FIG. 5 ensures that there is a dedicated channel path and dedicated disk storage to make the mirroring of the in-memory database 102 of the present invention perform as efficiently and in the same basic time frame as the main backup. This mirroring of the in-memory database 102 of the present invention guarantees that data integrity is built into the design of computer systems (such as computer system 100) based upon the in-memory database 102 of the present invention.

Given their use of shared memory 112 within each machine A and B, the processes of the servers 106 and the in-memory database 102 of the present invention routinely store in the shared memory 112 their current state, particularly the identification of the current transaction, processing statistics and other detailed current state information.

A separate process, the monitor, which is part of the in-memory database 102 of the present invention although not involved in any transaction processing, monitors all the life signs of the processes on the local machine A or B. The monitor helps detect certain modes of failure and quickly directs the computer system 100 to perform an automatic failover recovery to the partner machine A or B or, in other situations, instructs the operator to investigate and possibly initiate manual recovery. To recover a processing failure, the monitor may attempt to restart the primary machine's process, reboot the primary machine, or switch to the backup machine and start the failover process.

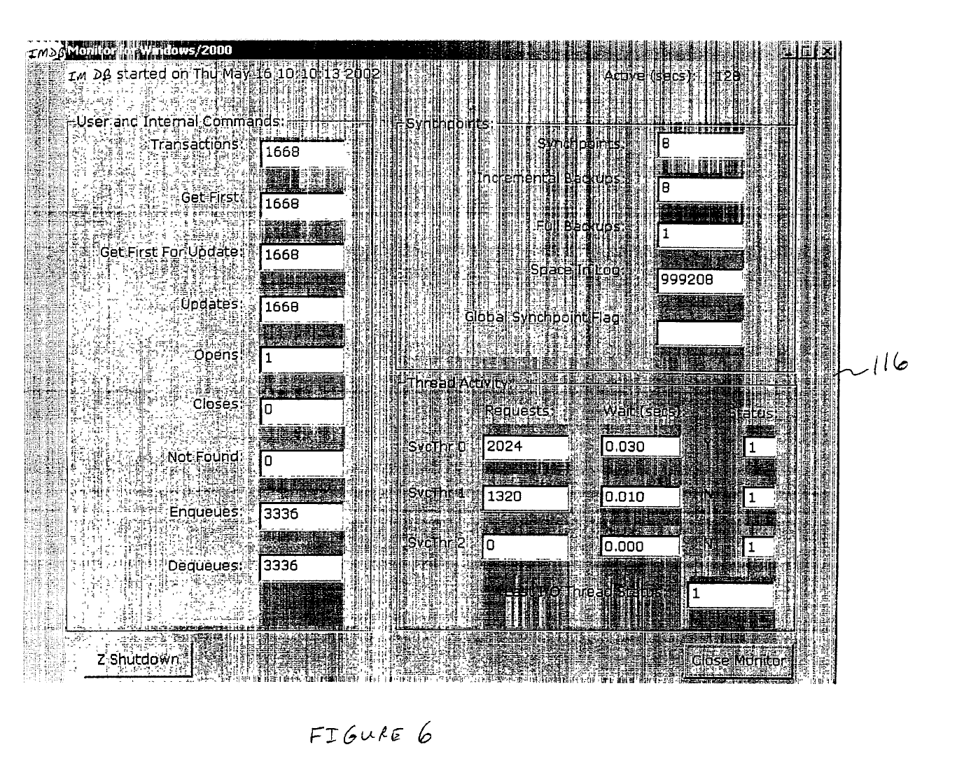

FIG. 6 shows an example of a monitor screen 116 for the in-memory database 102 of the present invention. As shown in FIG. 6, the monitor screen 116 shows the time that the in-memory database 102 was started and the amount of time that the in-memory database 102 of the present invention has been active. The monitor screen 116 also shows user and internal commands, synchpoints, and thread activity.

The user and internal commands section of the monitor screen 116 shows the number of transactions, which transaction to get first, which transaction to get first for update, the number of updates, the number of opens, the number of closes, the number not found, the number of enqueues, and the number of dequeues.

The synchpoints section of the monitor screen 116 shows the number of synchpoints, the incremental backups, the full backups, the space in log, and the global synchpoint flag.

The thread activity section of the monitor screen 116 shows the number of requests, the wait (in seconds) and the status for each of service threads 0, 1, and 2. The thread activity section of the monitor screen 116 also shows the least I/O thread status.

Application Program Interface (API)

The in-memory database of the present invention provides a simple API interface, of the key-result type, rather than SQL or other interface types. In the API interface of the present invention, the caller sets a key value in the interface area in memory, indicates the desired function, and the present invention places in the same area the response to the request. The target in-memory database of each process of the present invention contains a subset of data in the enterprise database. For example, one in-memory database contains a range of accounts within an enterprise customer account database.

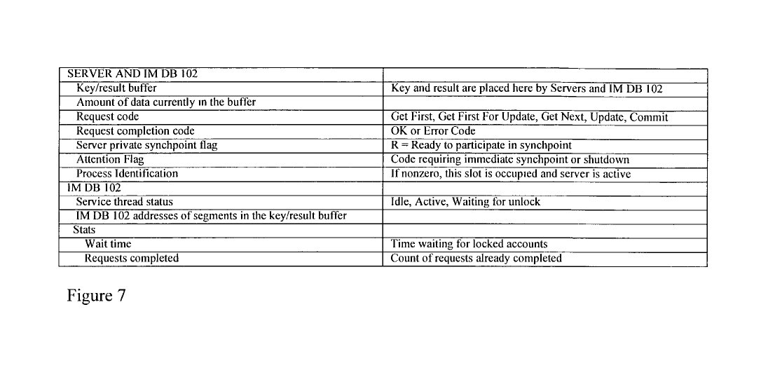

FIG. 7 shows an example of an in-memory database API of the present invention. The in-memory database of the present invention's API includes:

a. A shared memory slot containing a data buffer, flags, return codes and signaling variables;

b. Methods defined in the in-memory database (IM DB) API object to allow the caller to retrieve, update and perform commits. These methods are getFirst, getNext, getFirstForUpdate, update and commit. A getFirst places as many segments in the slot buffer as will fit. A getNext will continue with the remaining segments. A getFirstForUpdate will further lock the current account;

c. System events used by servers 106 to awaken the in-memory database 102 of the present invention's threads to perform a service and by the in-memory database 102 of the present invention to communicate to the server 106 that the request has been completed;

d. Status indicators in each data record specifying the action to be performed on the data record when the data record is returned by the server 106 to the in-memory database 102 of the present invention, following an update command. These indicators may be CLEAN (no action is required), REPLACED, DELETED or INSERTED.

These are examples of categories of information that can be communicated and presented through an API. FIG. 7 displays data fields which fall into category a and b.

Data organization

The in-memory database 102 of the present invention's memory is divided into two main areas: data and index.

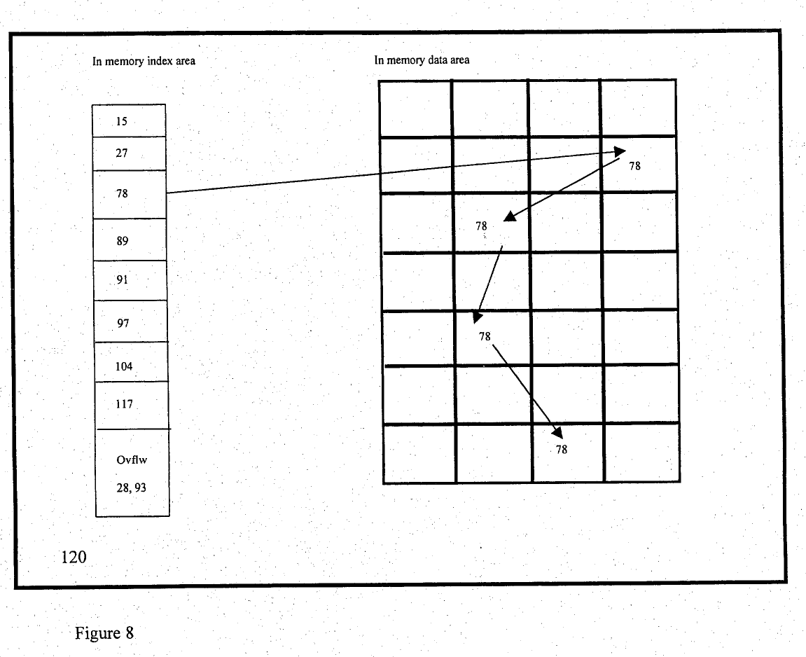

FIG. 8 illustrates the organization 120 of the index and data areas in the memory of the in-memory database 102 of the present invention.

The index includes a sequentially ordered list of keys and an overflow area for new keys. An index entry points to the first segment of data for the corresponding key value (78 in the example of FIG. 8). In the data area, all segments for the same key are chained together through pointers. Data segments and data records are used interchangeably in this document.

In the index (or key) area, the key entry contains the key (such as the account) and a memory pointer to the first segment of data for a particular key. Key entries are in collating sequence to allow fast searches, such as binary searches. The key entry also contains the size of the first segment of data, not shown in the figure.

Data stored in the in-memory database of the present invention is organized into segments, each segment having a length and a status indicator, key (such as an account number and a sequence number within the account), the data itself and a pointer and length value for the next segment of the same key or account. A retrieval request copies one or more of the requested segments from the in-memory database of the present invention's memory to the shared memory slot assigned to the server. An update request copies the data in the opposite direction, i.e., from the shared memory slot to the in-memory database of the present invention's memory.

A third in-memory log area, contains all the data segments modified during the current cycle. As described later, the segments are written to disk storage at the end of each processing cycle.

The in-memory database 102 of the present invention is optimized for applications that do not perform a high volume of inserts during online operations. New keys or accounts may have already been established prior to the beginning of high volume transaction processing and the index may already contain the appropriate entries even in the absence of corresponding data segments. New accounts can, however, be added during online operations. If index entries are added, the new index entries are temporarily stored in an overflow area, as shown in FIG. 8. Every closing and subsequently loading of the database 102 into memory re-sequences the index by incorporating the overflow area into the ordered portion of the index.

As discussed herein above with reference to FIG. 7, a request to the in-memory database 102 of the present invention is identified by a function code such as get first, get next, get for update, update and delete. The status byte, in each data segment, on being returned by the application hosted on server 106, indicates that the data is clean, i.e., has not been modified by the application or, conversely, that it has been updated, has been marked for deletion or is a newly inserted segment.

Database Locking

The in-memory database of the present invention's in-memory operation and the simplicity of the API allow for a very high level of concurrency in the data access. There are only a few users of the local in-memory database 102. These users 106, in turn, are not likely to request the segments for the same key (or accounts) at the same time. When the users 106 do request the same segments, however, a lock and unlock mechanism ensures that their data accesses do not interfere with one another. These locks operate automatically and only lock the data for the minimum duration needed.

When multiple users request to access the same data segments through application servers 106, the in-memory database 102 of the present invention decides the sequence of the access, usually by the sequence of the requests submitted. For example, when updating, a user locks all data segments of the accessed account, performs updates, and then releases these data segments to the next requestor. These data segments are locked in the in-memory database of the present invention by a user only for the duration of the time in which the user performs updates in the in-memory database, and the locks of the data segments are released as soon as the updates are complete and usually well before the next immediate commit point. Because these updates are for an in-memory database, the time required to complete such an operation is dramatically shorter than the time required to perform updates into databases residing on hard disks or storage disks. Therefore the time when data records are locked by specific users is also very short in comparison.

Periodic Synchpoints

In the high performance environment for which the in-memory database 102 of the present invention operates, synchpoints are not normally issued after each transaction is processed. Instead, the synchpoints are performed periodically after a site-defined time interval has elapsed. This interval is called a cycle.

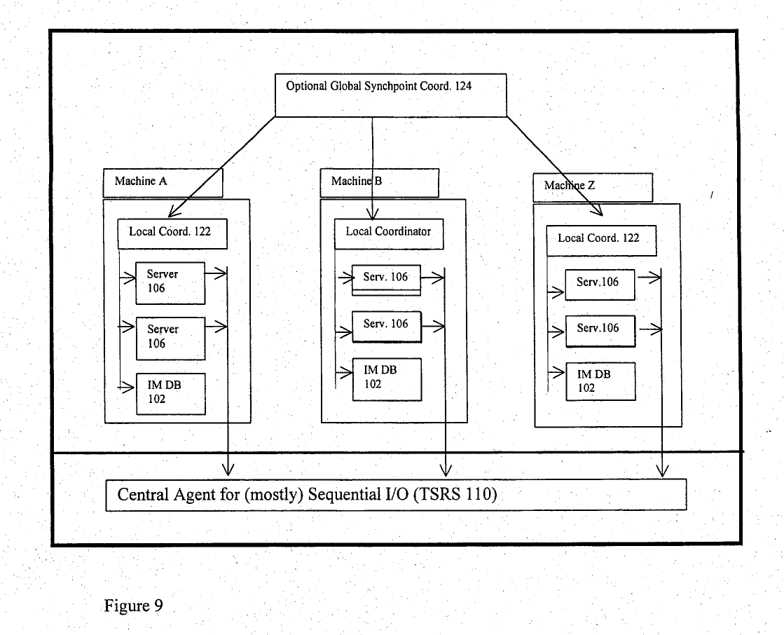

FIG. 9 illustrates the flow of synchpoint signals in the high performance computer system 100 shown in FIG. 2. More particularly, FIG. 9 illustrates the synchpoint signals in the in-memory database 102 of the present invention's high performance system 100.

The in-memory database 102 of the present invention's synchpoint logic is driven by a software component, considered to be part of the in-memory database 102 of the present invention, named the local synchpoint coordinator 122. The local synchpoint coordinator 122 is called local because the local synchpoint coordinator 122 runs on the same machine (A, B, or . . . Z) and under the same operating system image running the in-memory database 102 of the present invention and the application servers 106.

In turn, the local synchpoint coordinator 122 may either originate its own periodic synchpoint signal or, conversely, it may be driven by an external signaling process that provides the signal. This external process, named the global synchpoint (or external) coordinator 124, functions to provide the coordination signal, but does not itself update any significant resources that must be synchpointed or checkpointed.

When the synchpoint signal is received, the in-memory database 102 of the present invention, as well as its partner application servers 106, go through the synchpoint processing for the cycle that is just completing. Upon receiving this signal, all application servers 106 take a moment at the end of the current transaction in order to participate in the synchpoint. As disclosed herein below, the servers 106 will acknowledge new transactions only at the end of the synchpoint processing. This short pause automatically freezes the current state of the data within the in-memory database 102 of the present invention, since all of the in-memory database 102 of the present invention's update actions are executed synchronously with the application server 106 requests.

The synchpoint processing is a streamlined two-phase commit processing in which all partners (in-memory database 102 and servers 106) receive the phase 1 prepare to commit signal, ensure that the partners can either commit or back out any updates performed during the cycle, reply that the partners are ready, wait for the phase 2 commit signal, finish the commit process and start the next processing cycle by accepting new transactions.

One additional component that is included in this synchpoint process is the enterprise's central storage system, referred to as the Transaction Storage and Retrieval System (TSRS) 110. This component may be located on separate network machines and a communication protocol is used to store data and exchange synchpoint signals.

In a configuration in which the local synchpoint coordinator 122 keeps the time, the various machines (A, B, . . . Z) on the system 100 perform decentralized synchpoints. In decentralized synchpoints, synchpoints of all processes on each machine are controlled by the local synchpoint coordinator 122. Individual application servers 106 propagate the synchpoint signals to the TSRS 110, the enterprise's high volume storage.

Alternatively, the synchpoint local coordinators 122 themselves are driven by the external synchpoint coordinator 124 (or the global coordinator 124), which provides a timing signal and does not itself manage any resources that must also be synchpointed.

The synchpoint signals shown in FIG. 9 flow to the servers 106, the in-memory database 102 of the present invention, the TSRS 110, to provide coordination at synchpoint.

Database Backup

The in-memory database 102 of the present invention's main functions at synchpoint are: (1) to perform an incremental (also called partial or delta) backup, by committing to disk storage the after images of all segments updated during the cycle, and (2) perform a full backup of the entire data area in the in-memory database of the present invention's memory after every n incremental backups, where n is a site-specific number.

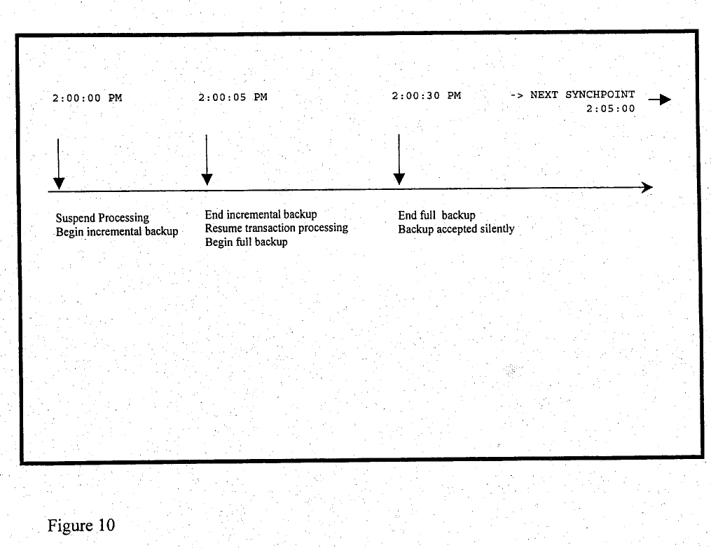

FIG. 10 illustrates the timing involved in this periodic backup process. More particularly, FIG. 10 illustrates incremental and full backups performed by the in-memory database 102 of the present invention.

As shown in FIG. 10, at the end of each processing cycle, the in-memory database 102 of the present invention performs an incremental backup containing only those data segments that were updated or inserted during the cycle. At every n cycles, as defined by the site, the in-memory database 102 of the present invention also performs a full backup containing all data segments in the database. FIG. 10 shows the events at a synchpoint in which both incremental and full backups are taken.

The in-memory database of the present invention's incremental backup involves a limited amount of data reflecting the transaction arrival and processing rates, the number and size of the new or updated segments and the length of the processing cycle between synchpoints. During the cycle, these updated segments (or after images) are kept in a contiguous work area in the in-memory database of the present invention's memory, termed the in-memory log. At the time of the incremental backup, these updates are written synchronously, as a single I/O operation, using a dedicated I/O channel and dedicated disk storage device, via a dedicated I/O thread and moving the data to a contiguously preallocated area on disk.

The care in optimizing this operation ensures that the pause in processing is brief. At the successful completion of the incremental backup, new transaction processing resumes, even if a full backup must also be taken during this synchpoint.

Every n cycles, where n is a site-specified number, the in-memory database 102 of the present invention will also take a full backup of its entire data area. The in-memory database of the present invention's index area in memory is not backed up since the index can be built from the data itself if there is ever a need to do so. Since the full backup involves a much greater amount of data as compared to the incremental backups, this full backup is asynchronous; it is done immediately after the incremental backup has completed but the system does not wait for its completion before starting to accept new transactions. Instead, using separate I/O operation and dedicated I/O channel, the full backup overlaps with new transaction processing during the early part of the new processing cycle. That is, the processing of the transaction is not interrupted by the full back-up of the in-memory database of the present invention, and continues during the full back-up of the present invention.

Although the full backup operation is asynchronous, all the optimization steps taken for incremental backups are also taken for full backups.

During incremental backup of the in-memory database of the present invention, the processing of transactions by the in-memory database is suspended briefly. The processing of transactions by the application servers, though, is not suspended during the full backup of the in-memory databases of the present invention.

This so-called hot backup technique is safe because: (1) new updates are also being logged to the in-memory log area, (2) there are at this point a full backup taken some cycles earlier and all subsequent incremental backups, all of which would allow a full database recovery, and (3) by design and definition, the system guarantees the processing of a transaction only at the end of the processing cycle in which the transaction was processed and a synchpoint was successfully taken.

The in-memory database 102 backup is provided to the TSRS 110, which processes at the performance level of 10,000 transactions per second, or ½ billion records per day. The TSRS 110 achieves this processing power by writing sequential output, and because of the sequential natutre of the output, without incurring the overhead of maintaining a separate log file. Thus, the TSRS 110 allows for complex billing calculations in, for example, a telephony billing application once per day or multiple times per day instead of once per month.

Recovery

Recovery involves temporarily suspending processing of new transactions, using the last full backup and any subsequent incremental backups to perform a forward recovery of the local and the central databases, restarting the server 106 processes, restarting the in-memory database 102 of the present invention and TSRS 110 and resuming the processing of new transactions.

In the forward recovery process, the last full backup is loaded onto the local database (such as the in-memory database 102 of the present invention) and all subsequent incremental backups containing the after images of the modified data segments are applied to the database 102, in sequence, thus bringing the database 102 to the consistent state the database 102 had at the end of the last successful synchpoint.

A corresponding recovery process may have to be performed on the partition of the Transaction Storage and Retrieval System (TSRS) 110 enterprise database that is affected by the recovery of the local in-memory database of the present invention database to bring both sets of data to a consistency point. Failures in the in-memory database 102 of the present invention machine or the in-memory database 102 of the present invention machine process will typically affect only the subset of the databases 102 that is handled by the failed machine or process.

Once these recovery operations are completed, processing of new transactions may resume.

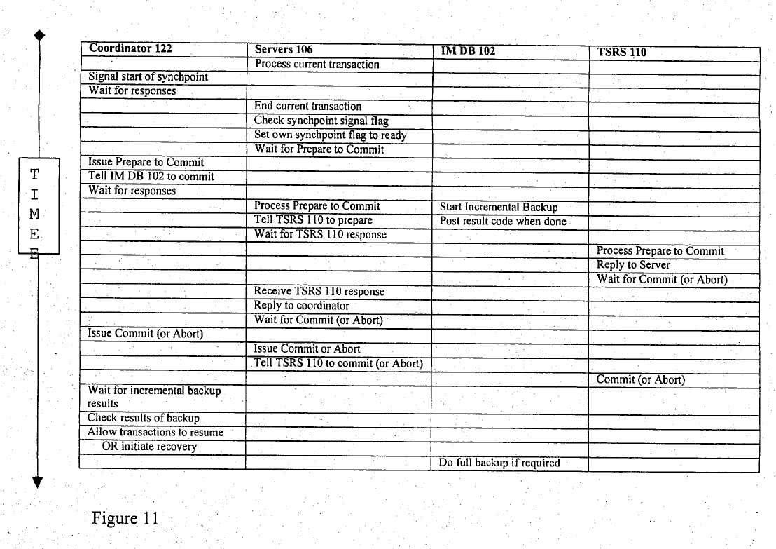

FIG. 11 shows a sequence of events for one processing cycle in a streamlined, 2-phase commit processing of the in-memory database 102 of the present invention. As shown in FIG. 11, the initial signaling from the Local Coordinator 122 to the Servers 106 is performed through shared memory flags. Moreover, the incremental backup is started in the in-memory database 102 of the present invention as an optimistic bet on the favorable outcome of the synchpoint among all partners, and its results can be reversed later if necessary.

The results of the full backup are checked well into the next processing cycle and are not represented in the table.

Applications with more moderate performance requirements may expand the interface with the in-memory database 102 of the present invention by adding a customized API layer and thus modify the ways in which the application interfaces with the in-memory database of the present invention.

On the other hand, the in-memory database 102 of the present invention can take advantage of larger address spaces already available on some platforms in order to support applications that require more memory at the same time that they also require the highest performance level that is obtainable.

In addition, in the high performance computer system 100, shown in FIG. 2, there is coordination between the major components to ensure commit integrity. Each record is committed. If there is an abnormal end to a record update, for example, then, because of data dependence, all updates are backed out throughout the high performance computer system 100. Thus, during each 5-minute interval of time between commit points, the high performance computer system 100 in which the in-memory database 102 of the present invention is included, processes 100 transactions per second×60 seconds per minute×5 minutes=30,000 transactions, which corresponds to approximately 30 megabytes (MB) of data.

In contrast, in the related art, all components of a computer system wait until a commit point is reached to refer to existing records, which locks existing records for a longer period of time and slows performance.

Moreover, the in-memory database of the present invention combines many concepts in a novel way, without losing sight of the main objective of high performance.

Possible uses of the present invention include any high performance data access applications, such as real time billing in telephony and car rentals, homeland security, financial transactions and other applications.

The in-memory database of the present invention is primarily designed to work in conjunction with other components that as a group implement high volume parallel transaction processing applications. These other components include the above-mentioned gap analyzer 108 and transaction storage and retrieval system (TSRS) 110.

In a high volume paralleled transaction system in the commodity computing arena, any synchronous I/O to or from disk storage may threaten to exceed a time budget allocated to process each transaction. The in-memory database system of the present invention reduces the time required to process each transaction.

Moreover, the in-memory database 102 of the present invention may co-exist with other, local databases, such as ORACLE or SQL databases.

Moreover, with the in-memory database 102 of the present invention, access to records in real time, such as in billing applications, is enabled, which would support interactive billing with complex billing calculations. In the related art, access to records is typically restricted until once a month (for monthly bills)which are generated in large, time-consuming batch runs.

Moreover, the in-memory database 102 of the present invention provides processing at the individual transaction level. That is, the in-memory database 102 of the present invention enables re-pricing and real time modification of discount plans at both the summary level and per transaction level in, for example, telephony billing applications. Using the in-memory database 102 of the present invention, the computer system 100 could simply set a flag to indicate re-pricing, which means that the in-memory database 102 of the present invention would take all prior records, modify the pricing data by transmitting the records back to the clients 104 (such as phone switches), for re-processing. Moreover, current records could be processed for re-pricing with the in-memory database 102 of the present invention.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An in-memory file system supporting concurrent clients allowing multiple updates on the same record by more than 1 of the clients, between commits, while maintaining commit integrity over a defined interval of processing.

2. An in-memory database system supporting concurrent clients allowing multiple updates on the same record by more than 1 of the clients, between commits, while maintaining commit integrity over a defined interval of processing.

3. The in-memory database system of claim 2, comprising instances of the in-memory database, each instance corresponding to at least one server in communication with the instance.

4. The in-memory database system of claim 3, wherein each server accesses the corresponding in-memory database instance through a shared memory.

5. The in-memory database system of claim 3, wherein each server is paired with another server, and each of the paired servers hosts a mirror in-memory database.

6. The computer system as in claim 2, wherein the in-memory database comprises an index area and a data area.

7. A computer system processing transactions and comprising:
client computers concurrently transmitting messages;
servers, in communication with the client computers, receiving the messages; and
in-memory databases, each in-memory database corresponding, respectively, to at least one of the servers, wherein said servers storing the messages in records of the respective in-memory databases, the in-memory databases allowing multiple updates on the same record by more than 1 of the client computers, between commits, while maintaining commit integrity over a defined interval of processing.

8. The computer system as in claim 7, wherein said servers are organized into pairs of servers, and an in-memory database of one of the servers in a pair of servers is a mirror in-memory database for another in-memory database of the other of the servers in the pair of servers.

9. The computer system as in claim 7, wherein each of the in-memory databases comprises an index area and a data area.

10. The computer system as in claim 7, wherein the computer system processes the transactions at the individual transaction level.

11. The computer system as in claim 7, wherein each of the servers accesses the corresponding in-memory database through a shared memory.

12. The computer system as in claim 7, wherein each of the servers accesses the corresponding in-memory database through an application program interface.

13. The computer system as in claim 7, wherein processing of the transactions is suspended during incremental backup of the in-memory databases.

14. The computer system as in claim 7, further comprising:
local coordinators corresponding, respectively, to each of the in-memory databases and to the servers associated with each of the in-memory databases, and coordinating the synchronization points of each of the corresponding in-memory databases and servers.

15. The computer system as in claim 14, further comprising:
a global coordinator in communication with each of the local coordinators and coordinating the synchronization points of the local coordinators.

16. A method of a computer system processing transactions, said method comprising:
supporting, by an in-memory database system, concurrent clients; and
allowing multiple updates on the same record of the in-memory database system by more than 1 of the clients, between commits, while maintaining commit integrity over a defined interval of processing.

17. The method as in claim 16, further comprising:
receiving, by servers, messages transmitted by the clients;
storing, in records of the in-memory databases, the messages received by the servers; and
locking, by the in-memory databases, one or multiple of the records only while updating the records.

18. The method as in claim 17, wherein the storing includes storing the records to the in-memory database corresponding to one of the servers, and to a mirror in-memory database corresponding to another of the servers paired with the one of the servers.

19. A computer-readable medium storing a program which, when executed by a computer system processing transactions, performs the functions comprising:
supporting, by an in-memory database system, concurrent clients; and
allowing multiple updates on the same record of the in-memory database system by more than 1 of the clients, between commits, while maintaining commit integrity over a defined interval of processing.

20. The medium as in claim 19, further comprising:
receiving, by servers, messages transmitted by the clients;
storing, in records of the in-memory databases, the messages received by the servers; and
locking, by the in-memory databases, one or multiple of the records only while updating the records.

21. The medium as in claim 20, wherein the storing includes storing the records to the in-memory database corresponding to one of the servers, and to a mirror in-memory database corresponding to another of the servers paired with the one of the servers.

22. The in-memory file system of claim 1 comprising an in-memory log tracking transactions applied to the in-memory file system.

23. The in-memory database system of claim 2 comprising an in-memory log tracking transactions applied to the in-memory database system.

24. The computer system as in claim 7, wherein each of the in-memory databases comprising an in-memory log tracking transactions applied to the in-memory database.

25. The method of claim 17, further comprising tracking, by an in-memory log, transactions applied to the in-memory database system.

26. The computer-readable medium of claim 19, further comprising tracking, by an in-memory log, transactions applied to the in-memory database system.

27. A computer processing transactions and comprising:
clients concurrently transmitting messages;
servers, in communication with the clients, receiving the messages; and
in-memory databases, each in-memory database corresponding, respectively, to at least one of the servers, wherein said servers storing the messages in records of the respective in-memory databases, the in-memory databases allowing multiple updates on the same record by more than 1 of the client computers, between commits, while maintaining commit integrity over a defined interval of processing.

28. The computer system as in claim 7, wherein processing of the transactions continues during full back-up of the in-memory databases.

29. The in-memory database system of claim 3, further comprising failover clusters, each failover cluster comprising groups of at least two servers, each server of each group of servers hosting at least one mirror in-memory database of another server of the group of servers.

30. The computer system as in claim 8, wherein the in-memory database comprises an in-memory log tracking transactions applied to the in-memory database, the transactions being simultaneously logged to the in-memory log of the in-memory database and to a in-memory log of the mirror in-memory database.
